(19) United States
(12) Patent Application Publication
(10) Pub. No.: US 2012/0133160 A1
(43) Pub. Date: May 31, 2012

(54) BUMPER APPARATUS

(75) Inventors: Thomas George Reichenbach, Carlsbad, CA (US); Orlando Genava Sherman, Oceanside, CA (US); Kurt Henry Danielson, Carlsbad, CA (US)

(73) Assignee: APTERA MOTORS, INC., Oceanside, CA (US)

(21) Appl. No.: 12/955,981

(22) Filed: Nov. 30, 2010

(51) Int. Cl. B60R 19/03; B23P 11/00; B62D 29/04

(52) U.S. Cl. 293/120; 296/191; 29/428

(57) ABSTRACT

An automotive vehicular bumper apparatus is provided. In another aspect, a bumper beam is attached to a composite body panel of an automotive vehicle. A further aspect provides a bumper beam including a first pair of generally V-shaped structural members and a second pair of generally V-shaped structural members joined together adjacent apexes thereof. In another aspect, a centralized bumper beam and a small width bumper are employed.

### BACKGROUND AND SUMMARY

The present invention relates generally to automotive vehicles and more particularly to an automotive vehicular bumper apparatus.

Bumper beams are commonly used to mount front and rear bumpers to an automotive vehicle frame or side rails. Exemplary conventional bumper beams are disclosed within the following U.S. Pat. Nos. 7,793,997 entitled “Bumper Beam Mounting” which issued to Karlander on Sep. 14, 2010; 7,568,755 entitled “Rear Frame Structure For Vehicle” which issued to Imada et al. on Aug. 4, 2009; 6,988,753 entitled “Bumper Beam Attachment Structure For Vehicle” which issued to Omura et al. on Jan. 24, 2006; and 5,080,410 entitled “Vehicle Bumper Beam” which issued to Stewart et al. on Jan. 14, 1992; all of these patents are incorporated by reference herein. Traditional bumper beams employ vehicular attachments adjacent the outboard corners of the side rails or frame, thereby being disadvantageous for center impacts. Moreover, conventional bumper beam designs are only intended for attachment to sheet steel body panels or chassis.

In accordance with the present invention, an automotive vehicular bumper apparatus is provided. In another aspect, a bumper beam is attached to a composite body panel of an automotive vehicle. A further aspect provides a bumper beam including a first pair of generally V-shaped structural members and a second pair of generally V-shaped structural members joined together adjacent apexes thereof. In another aspect, a centralized bumper beam and a small width bumper are employed. Furthermore, a method of attaching a bumper beam to an automotive vehicle is provided.

The automotive vehicle bumper apparatus of the present invention is advantageous over conventional bumper beam constructions. For example, the present bumper beam is structurally attached to a light weight composite body panel of a vehicle. Furthermore, the present bumper beam is advantageously resistant to at least dual axis impacts, including a rear end impact and a cross-car impact. The diagonal and multi-planar configuration of the present bumper beam apparatus is also advantageous by providing a very rigid and impact force-dispersing structure from a central bumper impact to a larger surface area of one or more body panels. Moreover, the present bumper beam apparatus is ideally suited for attachment to a vehicle with a very small tail panel section. The present bumper beam is also well suited for retaining a centralized bumper. Additional advantages and features of the present invention will be found in the following description and accompanying claims, as well as in the appended drawings.

### BRIEF DESCRIPTION OF THE DRAWINGS

FIG. 1 is a perspective view showing a first embodiment of an automotive vehicle bumper apparatus;

FIG. 2 is an exploded, rear perspective view showing the first embodiment apparatus;

FIG. 3 is a fully assembled, rear perspective view showing the first embodiment apparatus;

FIG. 4 is a rear perspective view showing a portion of the first embodiment apparatus;

FIG. 5 is center line cross-sectional view showing the first embodiment apparatus;

FIG. 6 is a rear perspective view showing portions of a second embodiment of the apparatus;

FIG. 7 is a rear perspective view showing portions of the second embodiment apparatus;

FIG. 8 is an exploded, rear perspective view showing portions of the second embodiment apparatus;

FIG. 9 is a cross-sectional view, taken along line 9-9 of FIG. 6, showing the second embodiment apparatus;

FIG. 10 is a cross-sectional view, taken along line 10-10 of FIG. 9, showing the second embodiment apparatus; and

FIG. 11 is a cross-sectional view, taken along line 11-11 of FIG. 7, showing the second embodiment apparatus.

### DETAILED DESCRIPTION

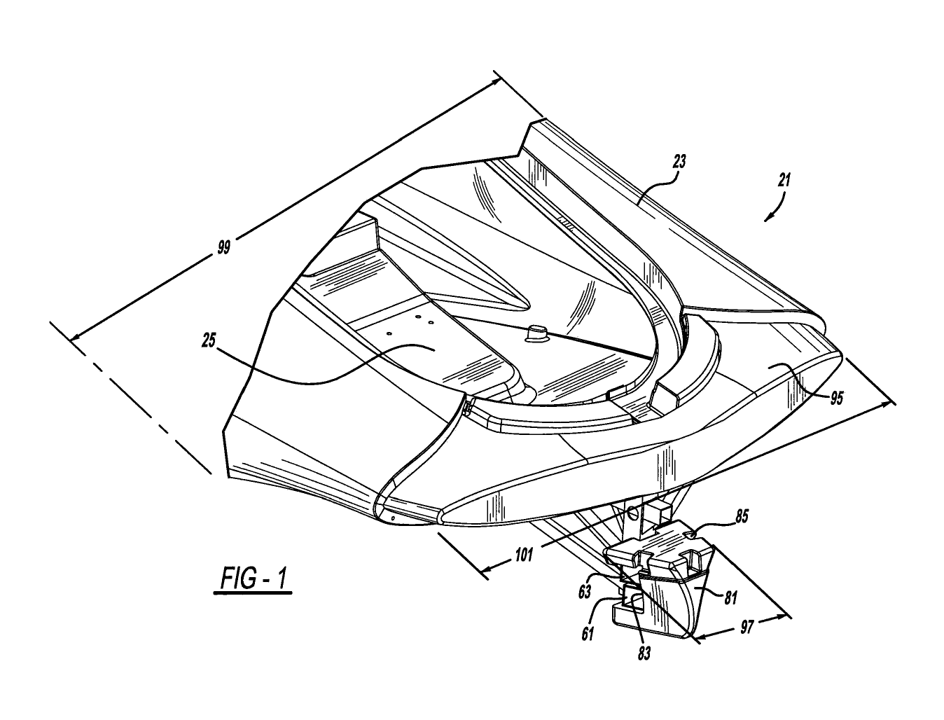

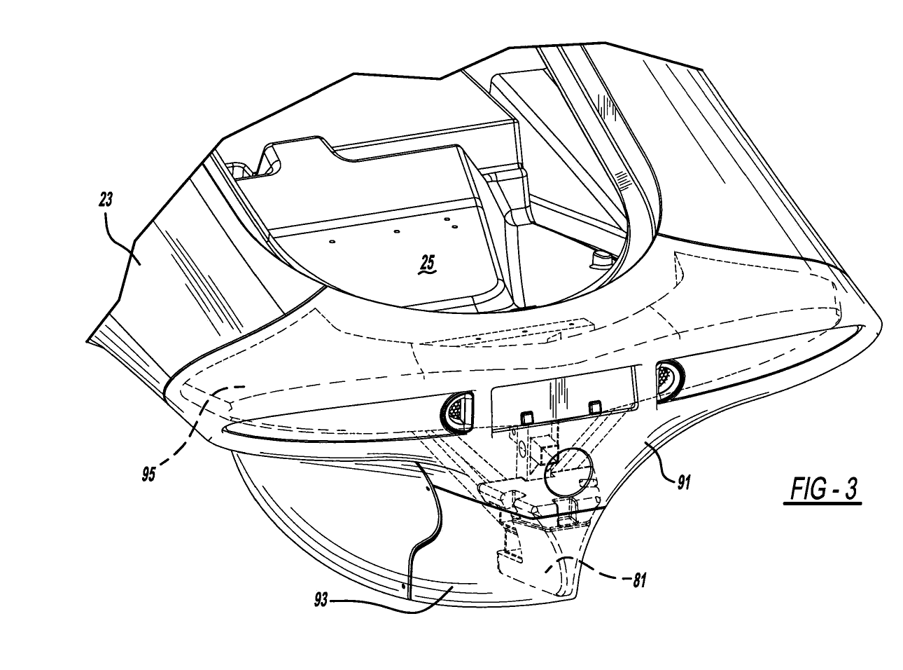

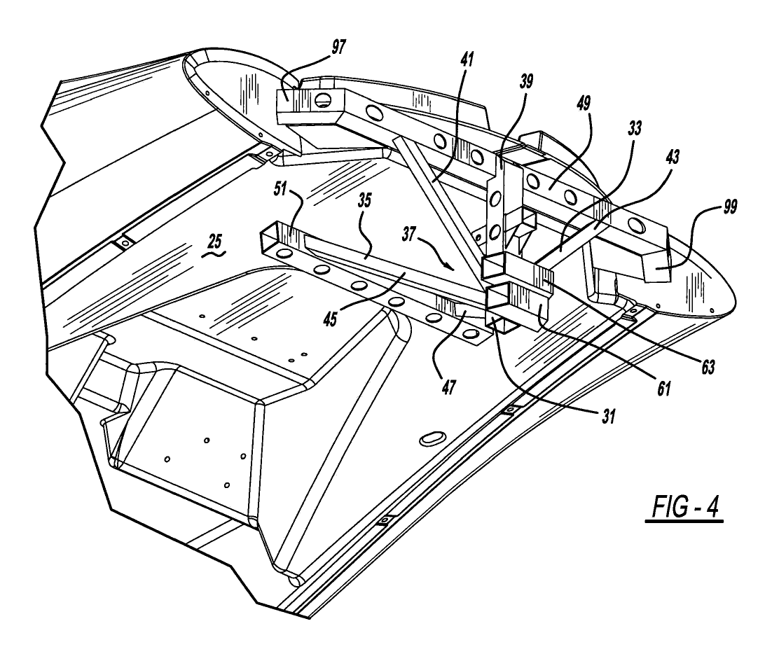

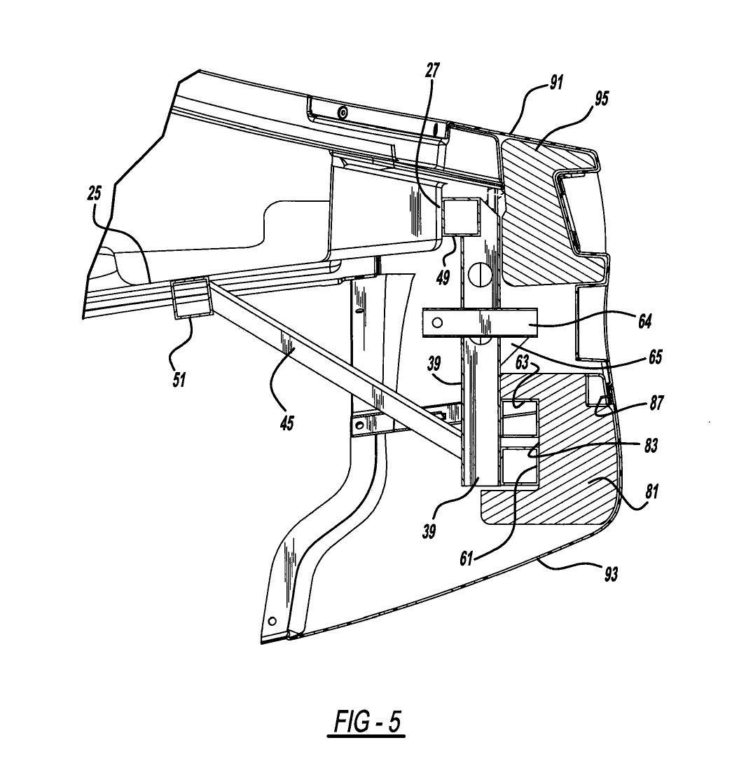

A first embodiment of an automotive vehicle bumper apparatus 21 is shown in FIGS. 1-5. The apparatus includes an automotive vehicle 23 having a composite floor pan body panel 25 with a generally horizontal bottom section and an upstanding rear wall thereof also referred to herein as a composite tail panel 27. Automotive vehicle 23 is preferably an electric vehicle or electric motor/internal combustion engine hybrid vehicle. The configuration is preferably like that disclosed in U.S. patent application Ser. No. 12/916,432 filed on Oct. 29, 2010, and entitled “Automotive Vehicle Composite Body Structure” which is incorporated by reference herein.

Apparatus 21 further includes a bumper beam 31 having a generally vertically planar triangular segment 33 and a generally diagonally planar triangularly configured segment 35. Segments 33 and 35 are joined together adjacent apexes 37 of the segments where they also join with a generally vertical structural member 39. Each triangularly shaped segment includes a pair of diagonal structural members 41, 43, 45 and 47 which define V-shaped pairs. A generally cross-vehicle elongated structural member 49 is attached to distal ends of diagonal members 41 and 43 opposite their apex and a generally cross-vehicle elongated structural member 51 is similarly attached to distal ends of diagonal members 45 and 47. Multiple slots, perforations or depressions may be cut or formed within two or more of the diagonal members in order to provide controlled collapsing, crumpling and deformation of the bumper beam structure during a rear impact, side impact or diagonally oriented rear corner impact. The double V-shaped configuration of bumper beam segments 33 and 35 widely disperses the impact loading to a wider surface area of the attached body panels, which is well suited for the centralized location of the bumper beam. Therefore, bumper beam 31 provides a dual-axis load bearing configuration, the majority of which extends below a horizontal plane defined by an adjacent bottom section of the floor pan.

At least one and preferably two cross-vehicle elongated mounting members 61 and 63 are attached to a rearwardly facing surface of vertical member 39. Furthermore, an optional fore-and-aft elongated trailer hitch receptacle 64 is also attached, via triangular braces 65, to a center of vertical member 39. All of the members are made from hollow, 6061 aluminum tubes, of generally square cross-section, which are welded together. Alternately, steel or other materials may be employed although such materials may be undesirably heavy especially for use with an electric vehicle having a composite body. Moreover, it is alternately envisioned that some or all of the diagonal and cross-vehicle elongated members may be solid bar-stock rather than hollow, dependent upon the impact strength requirement for each specific vehicle. It also envisioned that one or more bumper mounting members such as 61 and 63 can be attached to an upper section of vertical member 39.

A central lower bumper 81 has a side view C-shape with a forward facing notch 83 positioned about mounting members 61 and 63 in a snap-on manner and/or with adhesive bonding. Lower bumper 81 has a rearview triangular shape tapering toward its bottom. Lower bumper 81 additionally has four localized cavities 85 to provide clearance for interlocking tabs 87 between upper and lower facias 91 and 93, respectively. Furthermore, an upper bumper 95 is attached to an upper section of bumper beam 31 by snap fitting an internal cavity of the bumper onto ends of diagonal wings 97 and 99 of cross-vehicle elongated member 49 and/or adhesive bonding thereto. Lower bumper 81 has a cross-vehicle width 97 which is less than half of a maximum cross-vehicle width dimension 99 of floor pan 25. However, a cross-vehicle width dimension 101 of upper bumper 95 extends at least a majority of floor pan width 99. Lower bumper 81 is centrally aligned behind a rear wheel of vehicle 23 in a three-wheel vehicular configuration. Bumpers 81 and 95 are both preferably molded from an engineering grade polymeric material.

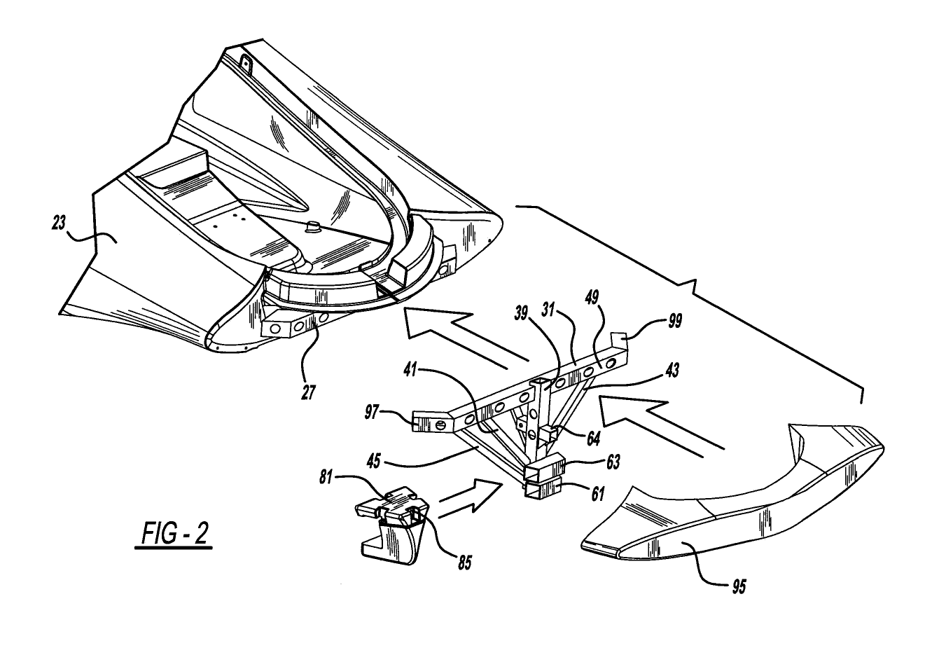

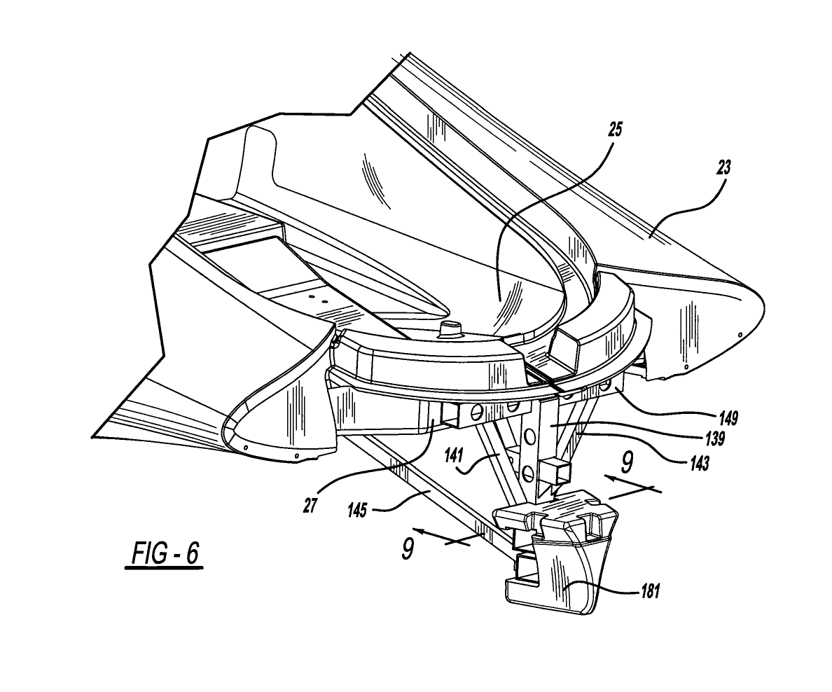

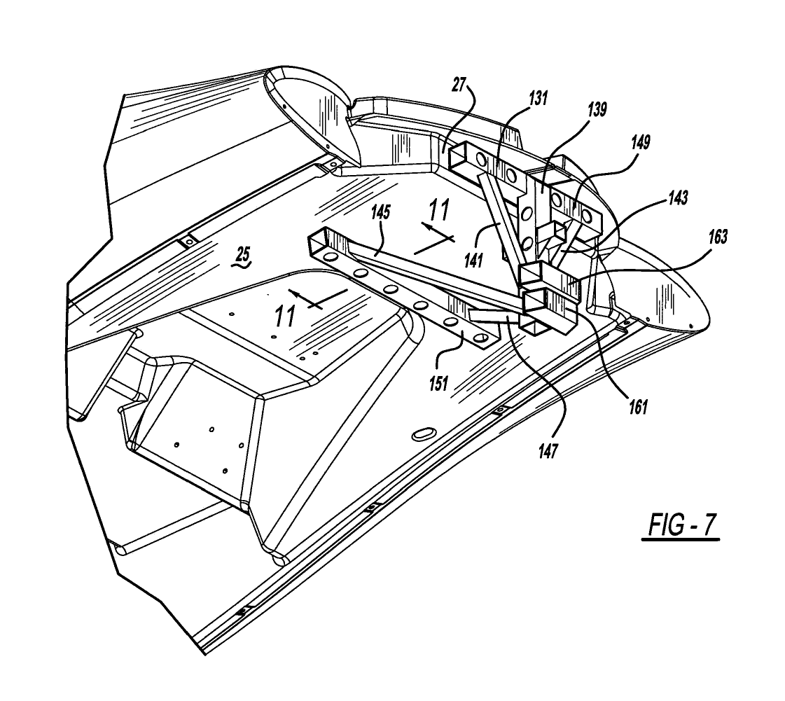

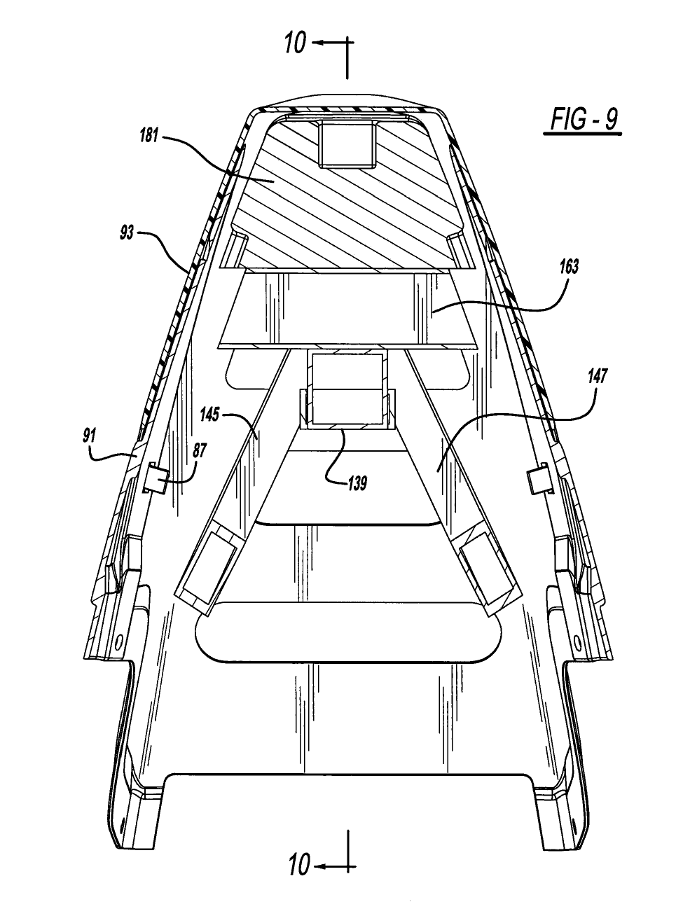

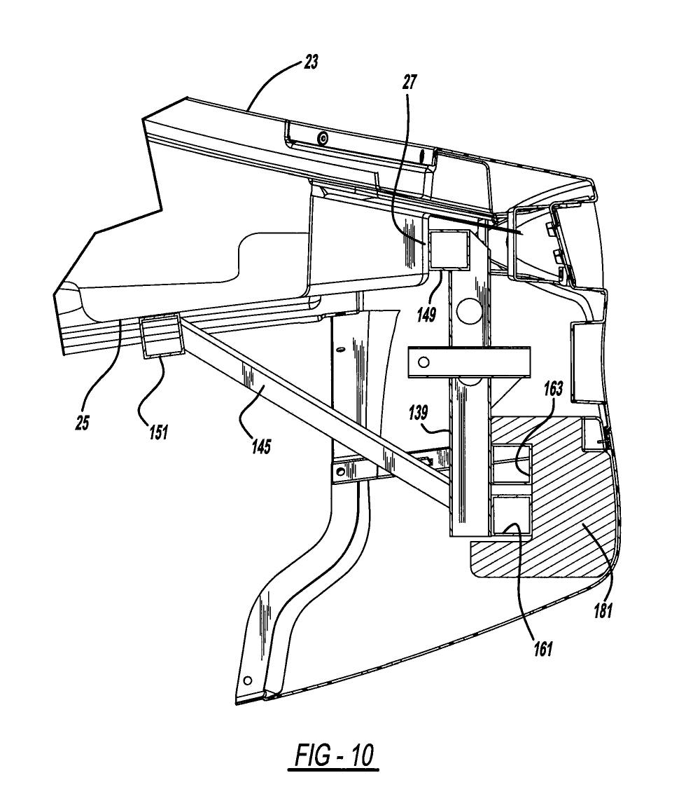

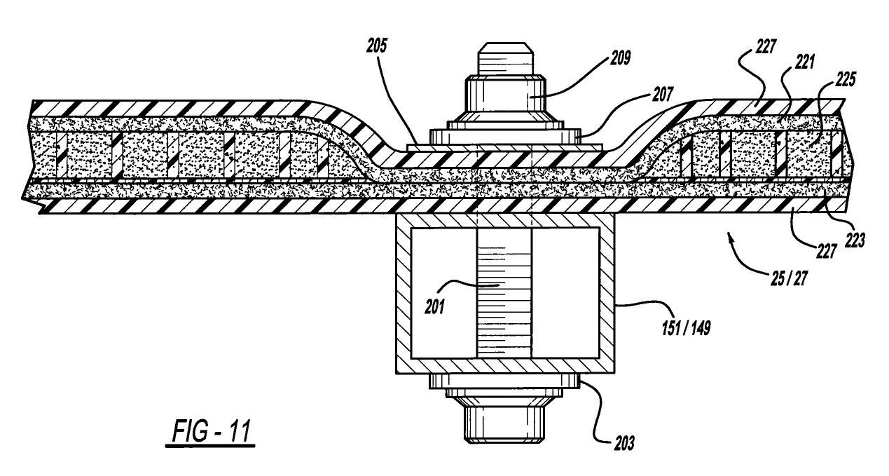

A second embodiment of the present bumper apparatus is shown in FIGS. 6-11. A bumper beam 131 has a similar triangular and V-shaped configuration for members 141, 143, 145 and 147, and cross-vehicle members 131 and 151, as with the prior embodiment. A vertical member 139 and mounting members 161 and 163 are also similarly provided. This embodiment, however, does not employ diagonal wings 97 and 99 (see FIG. 2) as compared to the prior embodiment since only a centralized lower bumper 181 is attached to bumper beam 131.

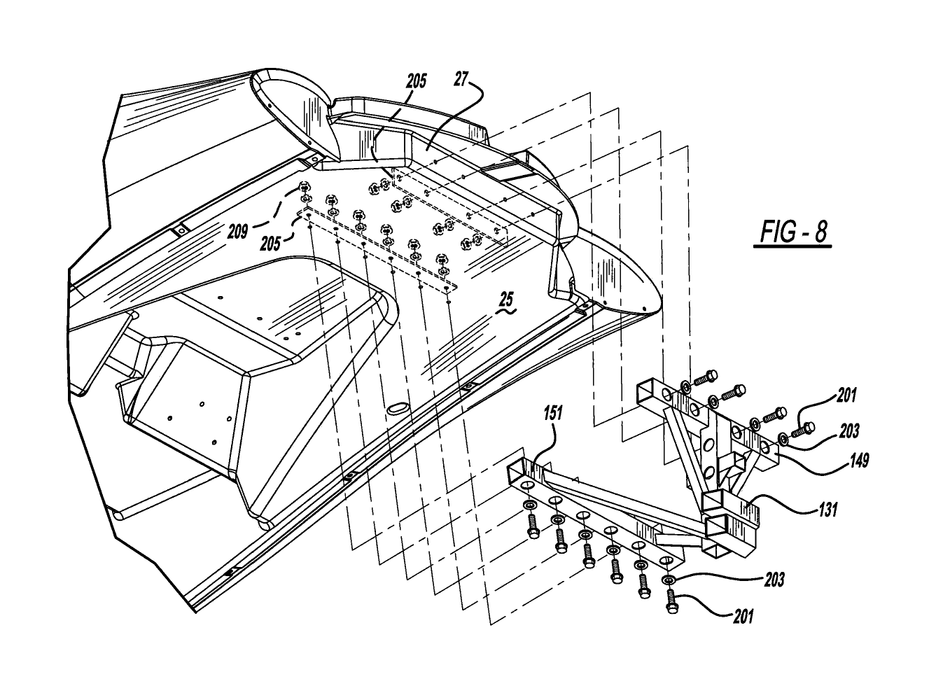

The direct attachment of bumper beam 131 to floor pan 25 and tail panel 27 is best illustrated in FIGS. 8, 10 and 11, and is applicable to all of the embodiments disclosed herein. Each cross-vehicle elongated member 149 and 151 have a set of holes through which threaded bolt fasteners 201 extend. A washer 203 is disposed between a head of each bolt 201 and a corresponding surface of member 151 or 149. A flat metallic backup plate 205 is located on an interior side of body panel 25 or 27 for receiving a lock washer 207 and nut 209 thereagainst. A loctite adhesive may optionally be used to prevent undesired disengagement. Composite panels 25 and 27 are preferably made from at least two sheets of long strand glass (or alternately polymeric) fibers 221 and 223, spaced apart by a honeycomb core 225. An epoxy or other resin 227 permeates within the internal layers while encapsulating them therein in a rigid manner. Where each member 151 and 149 is attached, core 225 of the composite panel has been removed so as to withstand the attachment compressive forces. The diverging diagonal member and cross-vehicle member configuration of bumper beam 131 is ideally suited for transferring the impact loading from the bumpers to a larger surface area at the tail and especially floor of the composite vehicle. This arrangement fits well for narrow rear end vehicles and/or those with a small tail panel.

While various embodiments of the present automotive vehicle bumper apparatus have been disclosed, it should be appreciated that other variations are possible. For example, additional diagonal, horizontal or vertical structural members and braces can be employed between or external to those disclosed herein. Furthermore, alternate bumper shapes, sizes and attachment constructions can be used although various advantages of the present apparatus may not be achieved. While a rear bumper apparatus has been disclosed, such a bumper apparatus can optionally be employed for a front bumper, for a conventional metal vehicle body construction, or above a floor pan, however, many advantages of the present apparatus will not be realized. The preferred tail panel is an integral single piece with the floor pan, however, they can alternately be separate members that are joined together. Moreover, extra brackets and fasteners may be utilized to retain the bumper(s) to the bumper beam. Alternate mechanical or adhesive fasteners can attach the bumper beam to the vehicle body. While various materials and dimensions have been disclosed, variations may be employed. It is intended by the following claims to cover these and any other departures from the disclosed embodiments which fall within the true spirit of this invention.

The invention claimed is:

1. An automotive vehicular apparatus comprising:
a vehicular body panel being a fiber reinforced resin composite; and
a bumper beam attached to the composite body panel.

2. The apparatus of claim 1, wherein the composite body panel is a floor pan.

3. The apparatus of claim 1, wherein the composite body panel is a substantially vertical tail panel.

4. The apparatus of claim 1, wherein the fiber is a long strand glass or polymeric fiber, and the composite body panel comprises a honeycomb core located between sheets of the fiber.

5. The apparatus of claim 1, wherein at least a majority of the bumper beam extends below a horizontal plane defined by an adjacent bottom section of the body panel which is a floor pan.

6. The apparatus of claim 1, wherein the bumper beam comprises:
at least a first pair of diagonal structural members oriented along a substantially vertical plane; and
at least a second pair of diagonal structural members forwardly and upwardly projecting from adjacent an apex of the first pair.

7. An automotive vehicular apparatus comprising a bumper beam further comprising:
at least a first pair of diagonal structural members oriented along a substantially vertical plane; and
at least a second pair of diagonal structural members forwardly and upwardly projecting from adjacent an apex of the first pair.

8. The apparatus of claim 7, further comprising a substantially vertical structural member extending between and joining the first pair of diagonal structural members adjacent the apex.

9. The apparatus of claim 8, further comprising a trailer hitch receptacle horizontally extending from the substantially vertical structural member.

10. The apparatus of claim 7, further comprising at least one cross-vehicle elongated bumper-mounting member attached adjacent the apex.

11. The apparatus of claim 7, further comprising:
a cross-vehicular elongated, vehicular tail panel-mounting member attached to ends of the first pair of diagonal structural members opposite the apex;
a cross-vehicle elongated, vehicular floor pan-mounting member attached to ends of the second pair of diagonal structural members opposite the apex;
all of the structural members being welded together; and
all of the structural members being hollow.

12. An automotive vehicular apparatus comprising:
a vehicular floor pan including a bottom rear surface defining a substantially horizontal plane; and
a bumper beam including at least a pair of elongated structural members having a substantially V-configuration;
at least a majority of the bumper beam, including at least a majority of the pair of members, being located below the substantially horizontal plane.

13. The apparatus of claim 12, further comprising another pair of elongated structural members having a substantially V-configuration, the pairs of structural members being coupled together adjacent apexes of both pairs.

14. The apparatus of claim 13, further comprising a substantially vertically elongated structural member extending between one of the pairs of V-configured structural members, the structural members all being welded together.

15. The apparatus of claim 12, further comprising a central rear bumper attached to the bumper beam, the central rear bumper having a cross-vehicle dimension of less than half a widest cross-vehicle dimension of the floor pan.

16. The apparatus of claim 15, further comprising a second bumper attached to the bumper beam and having a cross-vehicle dimension of at least a majority of the widest cross-vehicle dimension of the floor pan, the central and second bumpers being separate parts.

17. The apparatus of claim 12, wherein the floor pan is a composite material and the bumper beam directly attaches to an underside of the composite floor pan.

18. An automotive vehicular apparatus comprising:
an automotive vehicle having a maximum floor width dimension;
a bumper beam attached to the vehicle adjacent a center of the width; and
a bumper attached to the bumper beam, the bumper having a width less than half of the maximum floor width dimension of the vehicle.

19. The apparatus of claim 18, wherein the bumper is a rear bumper whose maximum width is less than one foot.

20. The apparatus of claim 18, wherein the bumper is positioned along a centerline of the vehicle and the bumper is a polymeric material.

21. The apparatus of claim 18, wherein the bumper has a side view C-shape with a central notch for fitting around a section of the bumper beam.

22. The apparatus of claim 18, wherein the bumper has a rear view taper, narrowing toward a bottom thereof.

23. The apparatus of claim 18, further comprising a second bumper positioned above the first bumper, the second bumper having a width at least a majority of the maximum floor width dimension of the vehicle.

24. The apparatus of claim 18, further comprising a single rearmost wheel positioned along a centerline of the vehicle in front of the bumper.

25. A method for attaching a bumper beam to an automotive vehicle, the method comprising:
(a) attaching a substantially vertically planar, triangularly shaped section of the bumper beam to a substantially vertical surface of a composite body panel of the vehicle; and
(b) attaching a substantially diagonally planar, triangularly shaped section of the bumper beam to a composite floor panel of the vehicle.

26. The method of claim 25, wherein the triangularly shaped sections are each defined by at least three spaced apart tubular and structural members, and one of the members of each of the sections is directly fastened to the adjacent composite panel.

27. The method of claim 25, further comprising attaching the substantially diagonally planar section to an underside surface of the floor panel so that an apex of the section extends downwardly and rearwardly from the floor pan.

28. The method of claim 25, further comprising adhering a polymeric rear bumper to a member extending from a rearward surface of the substantially vertically section of the bumper beam.

29. The method of claim 25, further comprising orienting a trailer hitch receiver to rearwardly project from a substantially vertically elongated structural member which bisects and is affixed to the vertical section of the bumper beam.
